(19) United States
(12) Patent Application Publication
(10) Pub. No.: US 2026/0077361 A1
(43) Pub. Date: Mar. 19, 2026

(54) FACILITIES FOR PRODUCING RECYCLED METALS WITH REDUCED CARBON EMISSIONS AND METHODS FOR OPERATING THESE FACILITIES

(71) Applicant: REMETAL INTERNATIONAL INC, Incheon (KR)

(72) Inventor: Hwan Cheol YEO, FULLERTON, CA (US)

(21) Appl. No.: 18/929,619

(22) Filed: Oct. 29, 2024

(30) Foreign Application Priority Data
Sep. 19, 2024 (KR) 10-2024-0126443

(51) Int. Cl. B03B 9/06; C22B 1/248

(52) U.S. Cl. CPC B03B 9/061; C22B 1/248

(57) ABSTRACT

A recycled metal production facility with reduced carbon emissions and a method of operating the same is disclosed. The recycled metal production facility with reduced carbon emissions may comprise: a closed receiving space in which a transported target metal treatment material is accommodated; a scrap classifying line to classify the target metal treatment material a crushing line to crush the classified target metal treatment material; a ventilation device; a vision camera; a grade determining unit to determine a grade of the metal scrap based on an artificial intelligence (AI) model; a transport unit; a solar power generation device; and a hydraulic energy storage system.

### CROSS-REFERENCE TO RELATED APPLICATION

This application claims priority to Korean Patent Application No. 10-2024-0126443, filed on Sep. 19, 2024, and all the benefits accruing therefrom under 35 U.S.C. § 119, the contents of which in its entirety are herein incorporated by reference.

### BACKGROUND

### 1. Field

The present disclosure relates to a recycled metal production facility with reduced carbon emissions and a method of operating the same, and more particularly, to a recycled metal production facility with reduced carbon emissions and a method of operating the same, which may allow an entire processing process including classification, crushing, grade determination, and transport of a waste metal treatment material to be performed in a closed space, may minimize the use of fossil fuel-based energy, and may enable eco-friendly facility operate through solar power generation and carbon emission reduction.

### 2. Description of the Related Art

Metal scrap is generated from a steel production process, a processing process of the steel-demand industry, or waste from steel-based products, is collected through a collection process of metal scrap distributors, and then is transported to a processing facility or a steel mill by using a vehicle.

In this case, a grade of the metal scrap transported to the processing facility or the steel mill is classified by an inspector by directly checking a type or a condition of the metal scrap with eyes or by checking the metal scrap on a monitor, and the cost according to the classified grade and a weight of the metal scrap is paid to a supplier.

Currently, a grade, purity, etc. of metal scrap in most sits are determined by visual inspection by an inspector of a specific institution or a quality inspection team of each manufacturer. All transactions are accompanied by a quality compensation procedure after delivery due to quality deviation in transactions between countries as well as Korea, with an average of 1.0% post-compensation.

Although numerous metal scraps such as iron, copper, aluminum, and stainless steel have recently been traded, the development of artificial intelligence (AI) inspection is attempted only for metal scrap with the largest volume of transactions and severe quality deviation, and AI inspection is used by steel companies for quality control of warehoused products, and thus, is not suitable for relatively small distribution companies.

Also, AI inspection models are trained according to domestic standards of each country and self-standards of large buyers, making it difficult to have universality in international transection markets.

Further, although metal scrap (recycled metal) is an eco-friendly material that drastically reduces carbon generation, a production process itself is not eco-friendly due to problems such as scattering dust, carbon emissions, and noise pollution, and a large amount of carbon is emitted during sea and land transportation of heavy cargo between countries.

Also, because a recovery rate and a grade of each metal scrap are determined by human visual inspection, there is always a dispute over quality and there is no systematic quality control. Because most of a metal scrap processing process is performed outdoors, there is no management for carbon emissions.

### SUMMARY

The present disclosure is directed to providing a recycled carbon production facility with reduced carbon emissions and a method of operating the same, which may allow an entire processing process including classification, crushing, grade determination, and transport of a waste metal treatment material to be performed in a closed space, may minimize the use of fossil fuel-based energy, and may enable eco-friendly facility operation through solar power generation and carbon emission reduction.

According to an embodiment, a recycled metal production facility with reduced carbon emissions comprises: a closed receiving space in which a transported target metal treatment material is accommodated; a scrap classifying line installed in the closed receiving space and configured to classify the target metal treatment material into metal scrap, non-metal scrap, and other scrap; a crushing line installed in the closed receiving space and configured to crush the classified target metal treatment material for each type; a ventilation device installed on a side of the closed receiving space and configured to discharge scattering dust generated in a classification process and a crushing process of the target metal treatment material to outside; a vision camera configured to obtain a captured image by capturing an image of an upper part of metal scrap that is crushed; a grade determining unit configured to determine a grade of the metal scrap according to a preset quality criterion, by analyzing the captured image based on an artificial intelligence (AI) model; a transport unit installed in the closed receiving space and configured to load the metal scrap whose grade is determined onto an electric transport vehicle and transport the metal scrap to a metal processing site; a solar power generation device installed outside the closed receiving space and configured to supply power to a power demanding unit from among the scrap classifying line, the crushing line, the ventilation device, the vision camera, the grade determining unit, and the transport unit through solar power generation; and a hydraulic energy storage system installed in at least one hydraulic device located in the closed receiving space and configured to recover and store hydraulic energy generated during an operation of the at least one hydraulic device.

According to an embodiment, the grade determining unit is configured to: classify a grade of the metal scrap according to whether the metal scrap corresponds to a vehicle outer skin, the metal scrap has a thickness of 3 mm or less, and the metal scrap has a thickness of 3 mm or less and is surface-plated, based on the captured image obtained through the vision camera, and filter out shadow noise formed by lighting, a thermal noise component, and a dust noise component formed by scattering dust in the obtained captured image, and then perform Fourier transform on the filtered captured image.

According to an embodiment, the recycled metal production facility with reduced carbon emissions further comprises: a carbon emission calculating unit configured to calculate carbon emissions generated in a processing process of the metal scrap and a grade determination result for the metal scrap, generate a grade report on recycled metal based on the carbon emissions, and provide the grade report to a management terminal.

According to an embodiment, the carbon emission calculating unit is configured to calculate expected carbon emissions for each type of metal treatment material based on the carbon emissions generated in the processing process of the metal scrap, and then provide a notification to at least one of the management terminal and a control system when it is determined that the expected carbons exceed preset reference carbon emissions.

According to an embodiment, the recycled metal production facility with reduced carbon emissions further comprises: a carbon emission operation control unit configured to control operation states of the ventilation device, the solar power generation device, and the hydraulic energy storage system so that, based on a calculation result of the expected carbon emissions, the expected carbon emissions are reduced to below the reference carbon emissions.

According to an embodiment, a method of operating a recycled metal production facility with reduced carbon emissions comprises: accommodating a transported target metal treatment material in a closed receiving space; classifying, through a scrap classifying line installed in the closed receiving space, the target metal treatment material into metal scrap, non-metal scrap, and other scrap; crushing, through a crushing line installed in the closed receiving space, the classified target metal treatment material for each type; discharging, through a ventilation device installed on a side of the closed receiving space, scattering dust generated in a classification process and a crushing process of the target metal treatment material to outside; obtaining, through a vision camera, a captured image by capturing an image of an upper part of the metal scrap that is crushed; determining, through a grade determining unit, a grade of the metal scrap according to a preset quality criterion, by analyzing the captured image based on an artificial intelligence (AI) model; through a transport unit installed in the closed receiving space, loading the metal scrap whose grade is determined onto an electric transport vehicle and transporting the metal scrap to a metal processing site; supplying, through solar power generation of a solar power generation device installed outside the closed receiving space, power to a power demanding unit from among the scrap classifying line, the crushing line, the ventilation device, the vision camera, the grade determining unit, and the transport unit; recovering and storing, through a hydraulic energy storage system installed in at least one hydraulic device located in the closed receiving space, hydraulic energy generated during an operation of the at least one hydraulic device; through a carbon emission calculating unit, calculating carbon emissions generated in a processing process of the metal scrap and a grade determination result for the metal scrap, generating a grade report on recycled metal based on the carbon emissions, and providing the grade report to a management terminal; and controlling, through a carbon emission operation control unit, operation states of the ventilation device, the solar power generation device, and the hydraulic energy storage system so that, based on a calculation result of expected carbon emissions, the expected carbon emissions are reduced to below reference carbon emissions.

According to the present disclosure, an entire processing process including classification, crushing, grade determination, and transport of a waste metal treatment material may be performed in a closed space, the use of fossil fuel-based energy may be minimized, and eco-friendly facility operation is possible through solar power generation and carbon emission reduction.

Further, according to the present disclosure, a grade of crushed metal scrap may be classified according to a preset quality criterion and then determined, and carbon emissions may be calculated and provided according to a processing process and a grade determination result.

In particular, according to the present disclosure, a distribution company in addition to a steel company may rapidly and accurately automate the quality inspection of metal scrap.

### BRIEF DESCRIPTION OF THE DRAWINGS

FIG. 1 is a diagram schematically illustrating an overall configuration of a recycled metal production facility 100 with reduced carbon emissions, according to an embodiment of the present disclosure.

FIG. 2 is a conceptual diagram illustrating an overall concept of producing recycled metal by using the recycled metal production facility 100 with reduced carbon emissions.

FIG. 3 is a conceptual diagram illustrating an overall concept of determining a grade of metal scrap through a grade determining unit 160.

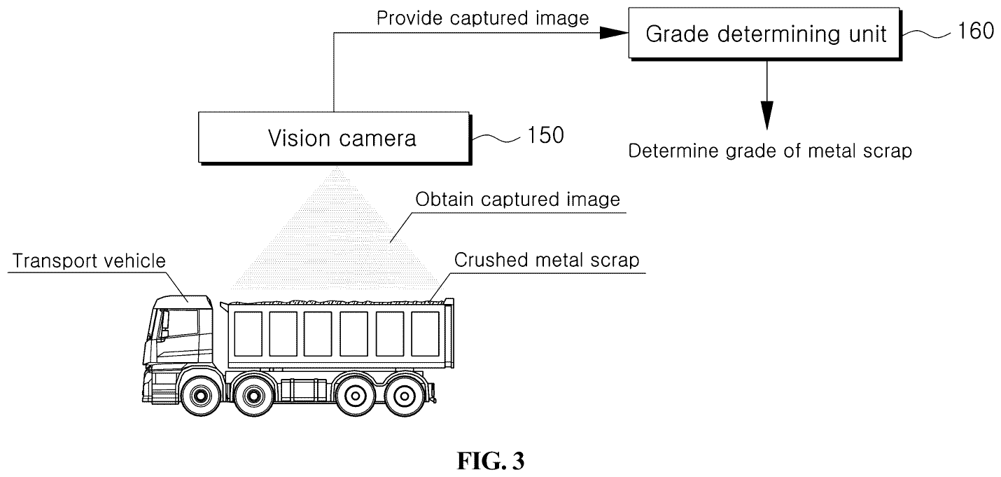

FIG. 4 is a diagram illustrating a schematic embodiment in which the grade determining unit 160 classifies a grade of metal scrap based on a captured image.

FIG. 5 is a diagram schematically illustrating a hardware configuration of the recycled metal production facility 100 with reduced carbon emissions according to an embodiment of the present disclosure.

FIG. 6 is a flowchart sequentially illustrating a series of operations of a method of operating a recycled metal production facility with reduced carbon emissions according to an embodiment of the present disclosure.

### DETAILED DESCRIPTION

Embodiments of the present disclosure will be described in detail with reference to accompanying drawings. However, in the description of the present disclosure, certain detailed explanations of well-known functions or configurations are omitted when it is deemed that they may unnecessarily obscure the essence of the present disclosure.

In the accompanying drawings, the same or corresponding components are denoted by the same reference numerals. Also, in the description of the following embodiments, repeated descriptions of the same or corresponding components will be omitted. However, even when a description of such components is omitted, such components are not intended to be excluded in an embodiment.

The advantages and features of embodiments of the present disclosure and methods of achieving the advantages and features will be described more fully with reference to the accompanying drawings, in which embodiments of the present disclosure are shown. The present disclosure may, however, be embodied in many different forms and should not be construed as being limited to the embodiments set forth herein; rather these embodiments are provided so that this disclosure will be thorough and complete, and will fully convey the concept of the present disclosure to one of ordinary skill in the art.

The terms used herein will be briefly described, and disclosed embodiments of the present disclosure will be described in detail. The terms used herein are general terms currently widely used in the art in consideration of functions in the present disclosure, but the terms may vary according to the intention of one of ordinary skill in the art, precedents, or new technology in the art. Also, some of the terms used herein may be arbitrarily chosen by the present applicant, and in this case, these terms are defined in detail below. Accordingly, the specific terms used herein should be defined based on the unique meanings thereof and the whole context of the present disclosure.

As used herein, the singular forms “a,” “an,” and “the” are intended to include the plural forms as well, unless the context clearly indicates otherwise. Also, the plural forms are intended to include the singular forms as well, unless the context clearly indicates otherwise. It will be understood that when a certain part “includes” a certain component, the part does not exclude another component but may further include another component, unless the context clearly dictates otherwise.

Also, the term “module” or “unit” used herein refers to a software component or a hardware component, and the “module” or “unit” performs certain tasks. However, the term “module” or “unit” does not mean to be limited to software or hardware. A “module” or a “unit” may be configured to be in an addressable storage medium or may be configured to operate one or more processors. Accordingly, a “module” or a “unit” may include, by way of example, at least one of components such as software components, object-oriented software components, class components, and task components, processes, functions, attributes, procedures, subroutines, segments of program code, drivers, firmware, microcode, circuitry, data, databases, data structures, tables, arrays, or variables. Functions provided in the components and the “modules” or “parts” may be combined into a smaller number of components and “modules” or “parts”, or further divided into additional components and “modules” or “parts.”

According to an embodiment of the present disclosure, a “module” or “part” may be implemented as a processor and a memory. The term “processor” should be interpreted broadly to encompass a general-purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other configuration. Also, the term “memory” should be interpreted broadly to encompass any electronic component capable of storing electronic information. The term “memory” may refer to various types of processor-readable media such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, magnetic or optical data storage, registers, etc. A memory may be said to be in electronic communication with a processor when the processor may read information from and/or write information to the memory. Also, a memory integrated in a processor may be in electronic communication with the processor.

In the present disclosure, a “system” may include at least one of, but not limited to, a computing device including a device management device, a server device, and a cloud device. For example, a system may include one or more computing devices or server devices. In another example, a system may include one or more cloud devices. In another example, a system may be configured and operate together with a computing device or a server device and a cloud device.

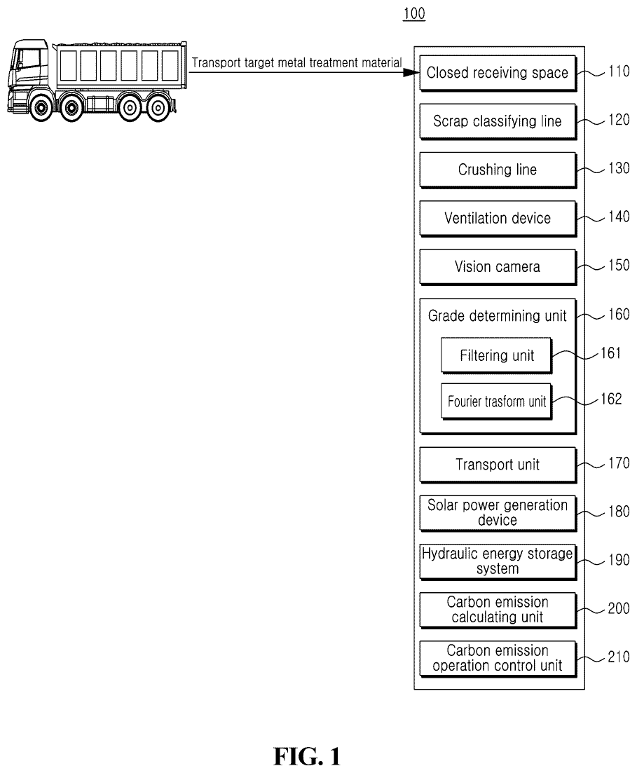

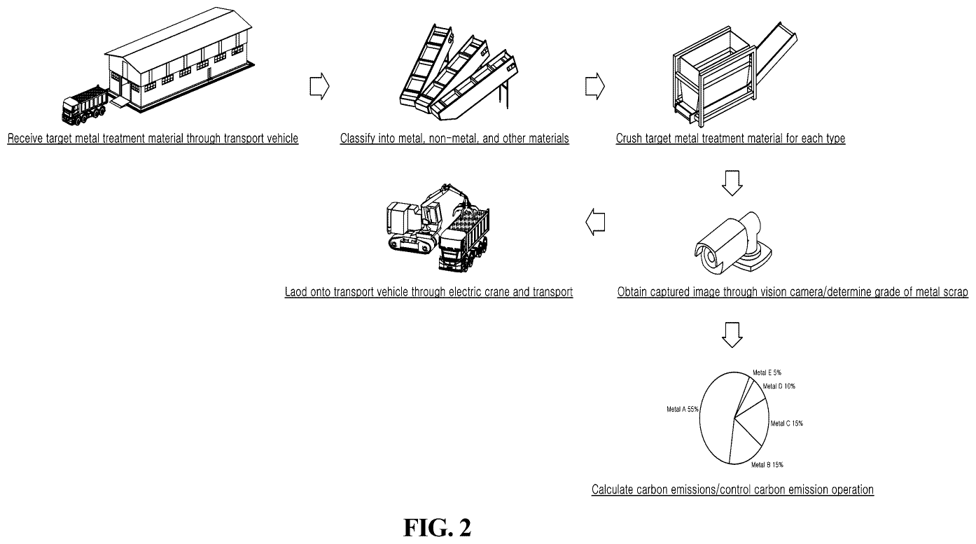

FIG. 1 is a diagram schematically illustrating an overall configuration of a recycled metal production facility 100 with reduced carbon emissions according to an embodiment of the present disclosure. FIG. 2 is a conceptual diagram illustrating an overall concept of producing recycled metal by using the recycled metal production facility 100 with reduced carbon emissions.

Referring to FIGS. 1 and 2, the recycled metal production facility 100 with reduced carbon emissions according to an embodiment of the present disclosure may roughly include a closed receiving space 110, a scrap classifying line 120, a crushing line 130, a ventilation device 140, a vision camera 150, a grade determining unit 160, a transport unit 170, a solar power generation device 180, a hydraulic energy storage system 190, a carbon emission calculating unit 200, and a carbon emission operation control unit 210.

First, the closed receiving space 110 may accommodate therein a transported target metal treatment material (e.g., a vehicle outer skin extracted from a scrapped vehicle), and the scrap classifying line 120, the crushing line 130, the ventilation device 140, the vision camera 150, the grade determining unit 160, the transport unit 170, the solar power generation device 180, the hydraulic energy storage system 190, the carbon emission calculating unit 200, and the carbon emission operation control unit 210 described below may be installed.

Also, a plurality of electric cranes for lowering a target metal treatment material transported through an electric transport vehicle (e.g., an electric truck) to a designated area within the closed receiving space 110 may be installed in the closed receiving space 110.

Each electric crane may operate based on power supplied through the solar power generation device 180 described below, and in this case, the hydraulic energy storage system 190 may be installed in each electric crane.

The hydraulic energy storage system 190 may be connected to a hydraulic device of each electric crane, may recover and store hydraulic energy generated during an operation of the hydraulic device and may utilize hydraulic energy stored during an operation of the electric crane, thereby drastically improving fuel efficiency and carbon emissions of the electric crane.

In an embodiment, the electric crane connected to the hydraulic energy storage system 190 may by driven by an electric motor, and may perform a task of lifting or lowering a load (e.g., the target metal treatment material or metal scrap) by using the hydraulic device.

The electric crane may include an electric motor, a hydraulic pump, a hydraulic cylinder, a boom, a winch, a hydraulic valve, a hydraulic oil tank, and a control system.

The electric motor is an element for providing power to the hydraulic device of the electric crane, and may drive the hydraulic pump by converting electricity into a mechanical rotational force.

The hydraulic pump may generate a necessary hydraulic force by compressing a fluid, and the hydraulic force may be used to move the hydraulic cylinder of the electric crane.

The hydraulic cylinder may perform a task of lifting or lowering a load by using the hydraulic force generated by the hydraulic pump, the hydraulic cylinder may include a tube in which a piston is located, and the boom or the winch of the electric crane may operate when a hydraulic fluid pushes the piston.

The boom is a main lifting structure of the electric crane, and may expand a working range and may be lengthened or shortened by the hydraulic cylinder.

The winch may lift a load by winding or unwinding a rope or a cable, and may include a drum, a gear, a brake system, etc.

The hydraulic valve may adjust a movement of the hydraulic cylinder by controlling the flow of a fluid and changing a direction.

The hydraulic oil tank may store a fluid used in the hydraulic device, and may perform a function of cooling and filtering a fluid.

The control system is an electronic system for controlling an operation of the electric crane, and may include an electric switch, a relay, a sensor, a programmable logic controller (PLC), etc.

Accordingly, the electric crane may be coupled to the hydraulic energy storage system 190, and when hydraulic energy is filled in the hydraulic cylinder connected to an arm, boom, or bucket of the electric crane, in a state where the hydraulic energy is recovered and stored, the hydraulic energy storage system 190 may use the stored hydraulic energy during an additional operation of the electric crane, thereby drastically improving fuel efficiency and reducing carbon emissions of the electric crane.

The scrap classifying line 120 may be installed in the closed receiving space 110 and may classify the target metal treatment material transported through the electric crane into metal scrap, non-metal scrap, and other scrap.

The scrap classifying line 120 may classify the target metal treatment material into metal scrap, non-metal scrap, and other scrap by using any of various classification methods such as a magnetic separation method, an eddy current separation method, a density separation method, an optical sorting method, or a material analysis method.

The magnetic separation method may involve separating metal scrap, non-ferrous scrap, and other non-magnetic materials by using a magnetic body located on a conveyor. In this case, a magnetic drum is a type in which a strong magnet is attached to a rotating drum, and when the target metal treatment material passes through the drum, magnetic metal scrap is attached to the dram and a non-magnetic material falls off.

The eddy current separation method is a method of separating non-metal scrap (e.g., aluminum, copper, brass, etc.). In this method, induced current is generated by a magnetic field, and the current generates a magnetic field in the opposite direction to push non-ferrous metals, allowing the non-ferrous metals such as aluminum and copper to move in a different path from other non-metal materials and to be separated into a separate collection container.

The density separation method is a method of classifying metal scrap, non-metal scrap, and other scrap by using a density difference and may involve spraying air to push out light-density materials.

The optical sorting method may involve classifying metal such as aluminum or copper or non-metal by detecting a color, gloss, and reflectance of a material by using a high-speed camera and a sensor. The material analysis method may involve classifying stainless steel or carbon steel by analyzing a chemical component of metal by using an X-ray fluorescence (XRF) analyzer or classifying scrap by analyzing composition or other characteristics of metal through optical spectrum analysis using a spectrum analyzer.

In addition to the above classification methods, the scrap classifying line 120 may classify the target metal treatment material into metal scrap, non-metal scrap, and other scrap by using various other methods.

The crushing line 130 may be installed in the closed receiving space 110 and may crush each target metal treatment material classified by the scrap classifying line 120 described above for each type.

In more detail, the crushing line 130 may include a primary shredder, a hammer mill, a conveyor system, a secondary shredder, a post-shredding treatment system, a soundproofing and vibration control system, an automation and control system, etc.

The primary shredder may shred large metal scrap into smaller and more manageable sizes, may have several powerful rotating blades attached, and may include a rotating blade for cutting and tearing metal chunks into small pieces and a high-power motor with strong power to process a large amount of metal scrap.

The hammer mill may be used to break down metal into smaller particles or make the metal soft, and may include a hammer blade for crushing metal by striking the metal with a high-speed rotating hammer so that metal pieces are crushed into small particles or fragments, and a screen designed to pass only particles of a certain size or less so that metal scrap of a desired size is obtained after crushing.

The conveyor system may move the metal scrap crushed through the primary shredder to a next processing step, and may include a belt conveyor, a magnetic drum, etc.

The secondary shredder may crush the metal scrap processed through the primary shredder into smaller sizes suitable for recycling, and may include a large number of smaller rotating blades than the primary shredder.

The post-shredding treatment system may refine and classify the metal scrap finely crushed through the primary shredder and the secondary shredder, and may include an eddy current separator, a vibration screen, a magnetic separator, etc.

The soundproofing and vibration control system is an element for improving a working environment and minimizing environmental impact on a surrounding area by minimizing noise and vibration of the primary shredder and the secondary shredder, and may include a soundproof cover for reducing noise by covering the periphery of a shredder, a damper for absorbing vibration, etc.

The automation and control system is an element for improving efficiency and minimizing human intervention by automatically controlling and monitoring a crushing process of the crushing line 130, and may automatically control all operations related to a shredder through a programmable logic controller (PLC), may maintain an optimal operation state through real-time monitoring, and may provide a human-machine interface (HMI) that allows an operator to easily monitor and control a process so that a state of the process and warnings are visually displayed.

The ventilation device 140 may be installed on a side (more specifically, an upper side) of the closed receiving space 110 and may discharge clean air to the outside by processing and filtering out a large amount of scattering dust generated in a classification process and a crushing process of the target metal treatment material.

In more detail, the ventilation device 140 may be installed above the closed receiving space 110, and may be divided into a filter system for removing scattering dust and a ventilation system.

To this end, the ventilation device 140 may include an intake system, a filtering system, a dust collector, an exhaust system, an automation and monitoring system, a noise and vibration control system, and a maintenance and safety system.

The intake system may rapidly suck up a large amount of scattering dust generated during a classification process and a crushing process of the target metal treatment material in the closed receiving space 110 and send the scattering dust to a processing system. To this end, the intake system may include a duct system connected to a ventilation fan and an inlet located at a position where a large amount of scattering dust is generated.

The filtering system may discharge only clean air to the outside by removing scattering dust from the indoor air of the closed receiving space 110 sucked through the intake system.

To this end, the filtering system may include a pre-filter for removing large particles and foreign substances, extending a lifespan of a subsequent filter, and improving overall system efficiency, a HEPA filter that is a high-efficiency particulate air filter, a cartridge filter, and an electrostatic precipitator for removing scattering dust by charging scattering dust particles in the air and then adsorbing the scattering dust particles on a dust collecting plate with an opposite charge.

The dust collector may collect and store dust that is filtered through the filtering system so that the dust is discharged or recycled, and to this end, the dust collector may include a hopper for collecting dust removed from a filter, and an exhaust system for automatically removing or discharging the collected dust at certain intervals.

The exhaust system may discharge filtered clean air to the outside to keep the air inside the closed receiving space 110 fresh. To this end, the exhaust system may include an exhaust fan for forcibly discharging filtered air to the outside, an exhaust duct for guiding the flow of air discharged to the outside through the exhaust fan and minimizing air flow resistance, and an exhaust outlet that is a final point through which purified air is efficiently discharged to the outside by setting a location and a direction suitable for an external environment.

The automation and monitoring system may monitor and automatically control an overall system operation state of the ventilation device 140 in real time to maintain efficiency. To this end, the automation and monitoring system may include a plurality of sensors for measuring a dust concentration in the air, filter saturation, and an air flow speed, a control system for automatically controlling an operation of each component through a programmable logic controller (PLC), and a human-machine interface (HMI) for providing real-time data and visually displaying a system state.

The noise and vibration control system may minimize noise and vibration generated during a process of driving the ventilation device 140, thereby improving a working environment and reducing impact on a surrounding environment. To this end, the noise and vibration control system may include a noise prevention case covering a fan and other noise generating devices and a vibration damper for absorbing vibration.

The maintenance and safety system is an element for ensuring a stable operation of the ventilation device 140 and ensuring worker safety, and may include an automatic cleaning system for automatically cleaning a filter when the filter is saturated with dust to maintain the performance of the filter in a best condition, and a safety locking device and protective equipment for worker safety when the filter needs to be replaced.

The vision camera 150 may capture an image of metal scrap classified into ferrous scrap, non-ferrous scrap, and other metals and then crushed to obtain a captured image and may provide the captured image to the grade determining unit 160.

To this end, the vision camera 150 may be installed at a high position in a factory to photograph an upper part of the metal scrap. In this case, the metal scrap may be crushed and then loaded into a cargo space of a transport vehicle (e.g., a truck) to be sold to a metal melting plant. In an embodiment, the vision camera 150 may capture an image of metal scrap piled up in a specific location to obtain a captured image when necessary in addition to the metal scrap loaded into the transport vehicle.

The captured image obtained through the vision camera 150 may be used to identify a type of the metal scrap and analyze a size, a shape, a color, and a surface condition of the metal scrap.

In an embodiment, the vision camera 150 may obtain a high-resolution captured image and may convert the captured image into digital data that may be processed by software.

Also, in an embodiment, in order to reflect reflection characteristics of a surface of the metal scrap, the vision camera 150 may minimize reflection by using lighting of a specific wavelength and grasp surface details.

The grade determining unit 160 may analyze the captured image obtained through the vision camera 150 based on an AI model and may determine a grade of the metal scrap according to a preset quality criterion.

In more detail, the grade determining unit 160 may identify a type of the metal scrap by analyzing a material, a color, and a surface condition of the metal scrap based on the captured image obtained through the vision camera 150 and may classify by size or determine a processing process by measuring a length, a width, and a thickness of the metal scrap, and may also inspect a grade by detecting defects or impurities on the surface of the metal scrap.

According to the quality criterion, a grade may be classified into a plurality of grades (e.g., A, B, D, etc.) according to whether the metal scrap corresponds to a vehicle outer skin, whether the metal scrap has a thickness of 3 mm or less, and whether the metal scrap has a thickness of 3 mm or less and is surface-plated.

In this case, the grade determining unit 160 may first perform a preprocessing process on the obtained captured image.

To this end, the grade determining unit 160 may include a filtering unit 161 configured to filter out shadow noise formed by lighting, a thermal noise component, and a dust noise component formed by scattering dust in the obtained captured image and a Fourier transform unit 162 configured to perform Fourier transform on the filtered captured image.

The captured image obtained through the vision camera 150 may include multidirectional shadow noise caused by a plurality of lighting devices installed at an image-capturing site and may also include fine thermal noise generated from the vision camera 150 and dust noise caused by numerous scattering dust.

Accordingly, in an embodiment, the filtering unit 161 may include a bilateral filter capable of removing thermal noise while preserving a linear component of the metal scrap. The bilateral filter may remove noise while preserving an outline of the metal scrap in the captured image.

Also, in an embodiment, the filtering unit 161 may include a haze removal filter capable of filtering out a dust noise component in a blurred captured image to remove scattering dust in the image-capturing site. The haze removal filter may be used to obtain a clear image by removing noise caused by haze or fog from the captured image. The haze removal filter mainly operates by modeling and correcting noise caused by atmospheric scattering in an image.

Accordingly, the filtering unit 161 of the present disclosure may effectively remove fine noise in the captured image by using the haze removal filter capable of removing noise while preserving an outline well.

In particular, in this process, the filtering unit 161 may calculate a pixel value of the captured image (a pixel value of the captured image that is clear without haze) through Equation 1.

$$J ( x ) = \frac{I ( x ) - A}{max ( t ( x ) , {t}_{0} )} + A \qquad [ Equation 1 ]$$

Here, J(x) denotes a pixel value of the captured image from which a dust noise component caused by scattering dust is removed through haze removal filtering, I(x) denotes a pixel value of the input captured image, t(x) denotes a transmission map in which haze affects a pixel in the captured image, and A denotes atmospheric light of a brightest portion in the captured image.

In this case, the filtering unit 161 may set a minimum value of t0 to 0.1 in order to prevent t0 from having a too small value.

By using Equation 1, the filtering unit 161 may obtain a clear captured image with reduced noise by removing haze in the captured image.

Also, in this process, the filtering unit 161 may use Equation 2 in order to calculate the transmission rate t(x).

$$t ( x ) = 1 - ω \cdot {min}_{y ∈ Ω ( x )} ( \frac{I ( y )}{A} ) \qquad [ Equation 2 ]$$

Here, ω denotes a transmission rate adjustment parameter value (0.95), and Ω(x) denotes a set of peripheral pixels for a pixel x.

By using Equation 2, the filtering unit 161 may calculate the transmission rate t(x) based on a darkest portion (minimum value) in the captured image.

Also, in an embodiment, the Fourier transform unit 162 may preserve geometric information of the metal scrap in the captured image and reduce lighting influence by using a homo-morphic filter.

The homo-morphic filter is a filter for relatively removing shadow influence by separating a lighting component that is a low-frequency component and a reflection component that is a high-frequency component in an image by using a logarithm, filtering a low-frequency band through Fourier transform, and performing inverse Fourier transform.

Also, in this process, the Fourier transform unit 162 may perform Fourier transform on the captured image by using Equation 3.

$$\{ I ( x , y ) \} = \hat{I} ( u , υ ) = {\sum }_{x = 0}^{M - 1} {\sum }_{y = 0}^{N - 1} I ( x , y ) \text{?} \qquad [ Equation 3 ]$$

$$\text{?} \text{indicates text missing or illegible when filed}$$

Here, I(x,y) denotes the input captured image, Î(u,b) denotes the captured image in a frequency domain, (u,v) denotes frequency coordinates, M and N denote a horizontal size and a vertical size of the captured image, and j denotes an imaginary unit.

By using Equation 3, the Fourier transform unit 162 performs two-dimensional Fourier transform on the captured image to convert the captured image into a frequency domain.

When the conversion of the captured image into the frequency domain is completed, the Fourier transform unit 162 removes a shadow by removing or adjusting a low-frequency component in the captured image by using a high-pass filter (HPF).

Also, the Fourier transform unit 162 may finally obtain a clear captured image from which shadow noise is removed, by converting the captured image of the frequency domain passing through the high-pass filter back into a spatial domain by using Equation 4.

$${I}_{shadow - free} ( x , y ) = {- 1}^{} \{ \{ I ( x , y ) \} \cdot ( 1 - \text{?} ) \} \qquad [ Equation 4 ]$$

$$\text{?} \text{indicates text missing or illegible when filed}$$

Here, I_{shadow-free}(x,y) denotes a final captured image obtained by removing a shadow from the original captured image.

Also, in an embodiment, the grade determining unit 160 may analyze the preprocessed capture image based on an AI model. The AI model may be a neural network algorithm model to which any of various deep learning techniques is applied such as a convolutional neural network (CNN) based on an inception module having excellent performance in image recognition, a deep neural network (DNN), a recurrent neural network (RNN), a restricted Boltzmann machine, a deep belief network (DBN), or a deep Q-network.

The grade determining unit 160 may determine the quality (or grade) of the metal scrap (the metal scrap may be located into the transport vehicle) according to whether the metal scrap corresponds to a vehicle outer skin, whether the metal scrap has a thickness of 3 mm or less, and whether the metal scrap has a thickness of 3 mm or less and is surface-plated through the preprocessed captured image, which will be described in more detail as follows.

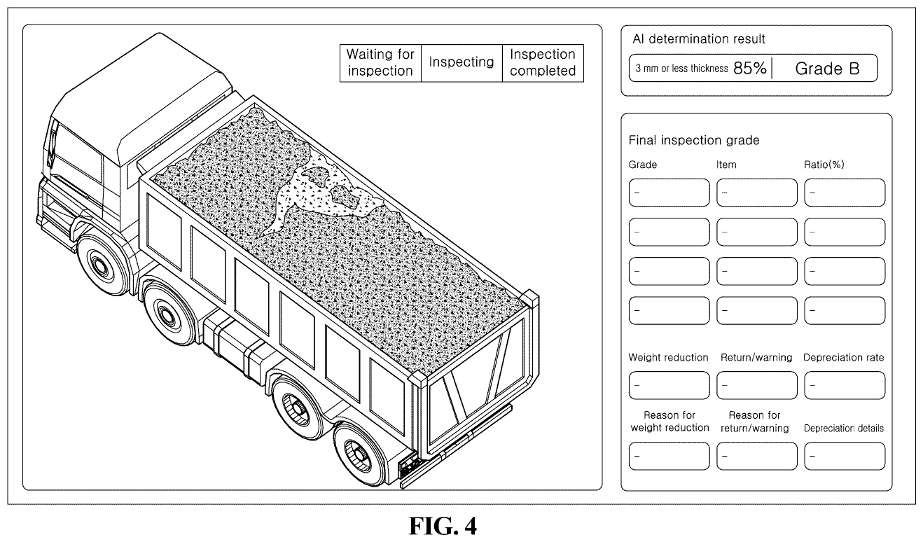

FIG. 4 is a diagram illustrating a schematic embodiment in which the grade determining unit 160 classifies a grade of metal scrap based on a captured image.

Referring to FIG. 4, the grade determining unit 160 may determine whether the metal scrap corresponds to a vehicle outer skin, the metal scrap has a thickness of 3 mm or less, or whether the metal scrap has a thickness of 3 mm or less and is surface-plated by using a classification DNN model for the obtained captured image, and may classify a grade of the metal scrap into A, B, D, etc. based on a determination result.

In particular, in this process, the grade determining unit 120 may visualize by overlapping the captured image and a grade classification prediction result of the metal scrap together. For example, the grade determining unit 120 may visualize an area close to a specific grade of the metal scrap (A, B, D, etc.) from among areas of the metal scrap in red or blue so that a worker or a manager recognizes the area more easily.

The transport unit 170 loads metal scrap whose grade is determined through the grade determining unit 160 onto an electric transport vehicle and transports the metal scrap to a metal processing site where each metal scrap is processed.

To this end, the transport unit 170 may include a plurality of electric cranes for loading the metal scrap whose grade is determined onto an electric transport vehicle.

Each electric crane may operate based on power supplied through the solar power generation device 180, and in this case, the hydraulic energy storage system 190 may be installed in each electric crane. Also, the electric crane may be driven by an electric motor, and may perform a task of lifting or lowering a load (e.g., the target metal treatment material or the metal scrap) by using the hydraulic device.

The solar power generation device 180 may be installed outside the closed receiving space 110, and may supply power to a power demanding unit from among the scrap classifying line 120, the crushing line 130, the ventilation device 140, the vision camera 150, the grade determining unit 160, and the transport unit 170 through solar power generation.

The solar power generation device 180 is a sustainable and eco-friendly energy solution, and may contribute to reducing power costs and carbon emissions of the recycled metal production facility 100 with reduced carbon emissions.

To this end, the solar power generation device 180 may include solar panels, an inverter, a power management system, a battery storage system, a grid connection, a protection and safety system, and a maintenance and monitoring system.

Each solar panel may be installed at an upper position outside the closed receiving space 110 and may absorb solar energy and convert the solar energy into electrical energy. The solar panel may include a plurality of solar cells, and each cell may absorb sunlight and generate direct current (DC) power. The cell may be formed of a silicon-based semiconductor material. Also, the solar panel may be arranged at an optimal angle to absorb as much sunlight as possible.

The inverter may convert DC power generated by the solar panel into alternating current (AC) power used in the recycled metal production facility 100 with reduced carbon emissions. The inverter may include a DC-AC converter for adjusting a voltage and a frequency of DC power generated by the solar panel, and a maximum power point tracker (MPPT) for enabling the solar panel to produce as much power as possible for a given period of time by optimizing an output of the solar panel.

The power management system may efficiently manage and distribute power produced by the solar power generation device 180 in the closed receiving space 110. The power management system may include a power distribution device for distributing power generated from sunlight to each demanding unit according to a power usage pattern of the closed receiving space 110, a battery system for storing surplus power and using the surplus power when necessary, and a monitoring system for monitoring a solar power generation state and power consumption in real time and continuously improving system efficiency through data analysis.

The battery storage system may store surplus power generated through solar power generation and use the surplus power when necessary, and may include a lithium-ion battery with high energy density and excellent charging and discharging efficiency, and a battery management system (BMS) for automatically supplying power when power demand is high or solar power is insufficient to contribute to improving the stability of power usage and reducing dependence on an external power grid.

The grid connection may connect the solar power generation device 180 to an internal power system of the closed receiving space 110 and the external power grid, and may be mutually configured to smoothly interoperate with an existing power system inside a plant. Also, a two-way connection may be performed so that excess power is transmitted to the external power grid or power is supplied from the external power grid when power is insufficient. The grid connection may include a power meter for accurately measuring power used by the recycled metal production facility 100 with reduced carbon emissions and power transmitted to the outside and calculating power costs when there is saved power.

The protection and safety system may ensure safe electrical operations of the solar power generation device 180 and the recycled metal production facility 100 with reduced carbon emissions, and may include a surge protection device for preventing damage caused by lightning or electrical surges to protect the solar panel and the inverter, an insulation monitoring system for monitoring an insulation state of the power system to prevent an electrical accident such as leakage or short-circuit, and an emergency cut-off device for automatically cutting off the solar power generation device 180 when a problem occurs in the power system in the closed receiving space 110 to ensure safety.

The maintenance and monitoring system may continuously monitor to maintain the performance of the solar power generation device 180 and always keep equipment in an optimal condition. To this end, the maintenance and monitoring system may include a remote monitoring device for remotely monitoring system performance in real time to immediately respond to a problem and an automatic diagnostic device for detecting equipment failure in advance through an automatic diagnostic function of the system and optimizing a maintenance cycle. Because regular maintenance such as cleaning of the solar panel, inspection of the inverter, and monitoring of a battery state may be performed through the maintenance and monitoring system, a lifespan of the system may be extended and efficiency may be maintained.

The hydraulic energy storage system 190 may be installed for each of at least one hydraulic device located in the closed receiving space 110, and may recover and store hydraulic energy generated during an operation of each hydraulic device and may use the stored hydraulic energy, thereby drastically improving fuel efficiency and reducing carbon of each hydraulic device.

Accordingly, the hydraulic energy storage system 190 may be connected to each hydraulic device, and when hydraulic energy is filled in a hydraulic cylinder connected to an arm, boom, or bucket, in a state where the hydraulic energy is recovered and stored, the hydraulic energy storage system 190 may use the stored hydraulic energy during an additional operation of the hydraulic device, thereby drastically improving fuel efficiency and reducing carbon emissions of the hydraulic device.

The carbon emission calculating unit 200 may calculate carbon emissions generated in a processing process of the metal scrap and a grade determination result for the metal scrap through the grade determining unit 160, may generate a grade report on recycled metal based on the calculated carbon emissions, and may provide the grade report to a management terminal.

In more detail, the carbon emission calculating unit 130 may calculate carbon emissions based on a material consumed in a metal scrap processing in the scrap classifying line 120, the crushing line 130, the ventilation device 140, the vision camera 150, the grade determining unit 160, and the transport unit 170, etc. and corresponding energy consumption.

For example, the carbon emission calculating unit 200 may convert either or both of purchase history and emission factor information into standardized information so that a purchase history and an emission factor for each metal scrap are correlated, and may calculate carbon emissions corresponding to the purchase history based on the standardized information. The standardized information does not refer to information with a fixed time point or unit, but may refer to any form in which one or more of both information are converted so that a user's purchase history and emission factor are correlated.

Also, in an embodiment, the carbon emission calculating unit 200 may determine carbon emissions generated in a process of processing a specific amount of specific classified metal scrap by using an AI model.

In more detail, the carbon emission calculating unit 200 may first define a basic variable to determine carbon emissions generated in a process of processing a specific amount of specific classified metal scrap, by using a neural network algorithm model to which any of various deep learning techniques is applied such as a convolutional neural network (CNN), a deep neural network (DNN), a recurrent neural network (RNN), a restricted Boltzmann machine, a deep belief network (DBN), or a deep Q-network.

For example, Q may denote a total amount of processed metal scrap (tons), E may denote energy required to process 1 ton of metal scrap (kWh/ton), η may denote energy efficiency of a process (0<η<1), CE may denote a carbon emission factor according to energy consumption (kg CO₂ e/kWh), and CP may denote carbon emissions directly generated in a metal scrap processing process (kg CO₂ e/ton).

In this case, the carbon emission calculating unit 200 may calculate carbon emissions due to energy consumption based on Equation 5.

$${C}_{energy} = Q \times \frac{E}{η} \times {C}_{E} \qquad [ Equation 5 ]$$

Here, E/η denotes an energy value actually consumed by considering process efficiency, and C_{energy} denotes carbon emissions generated due to energy consumption.

Also, the carbon emission calculating unit 200 may calculate total carbon emissions based on Equation 6.

$${C}_{total} = Q \times ( \frac{E}{η} \times {C}_{E} + {C}_{P} ) \qquad [ Equation 6 ]$$

Here, Cₜₒₜₐₗ denotes carbon emissions generated in a process of processing Q tons of metal scrap.

Accordingly, the carbon emission calculating unit 200 may determine carbon emissions generated in an overall processing process based on the amount of processed metal scrap, energy efficiency of the process, an energy carbon emission factor, and carbon emissions directly generated from the process.

Based on this, the carbon emission calculating unit 200 may calculate carbon emissions generated when processing a specific amount of metal scrap, thereby making it possible to evaluate and optimize the environmental impact of the process and generate and provide a grade report to the management terminal.

For example, the carbon emission calculating unit 200 may classify a grade into grade A corresponding to low carbon emissions, grade B corresponding to medium carbon emissions, and grade C corresponding to high carbon emissions according to a criterion for determining an environmental evaluation grade based on carbon emissions.

Also, in an embodiment, the carbon emission calculating unit 200 may reflect environmental regulations and industrial standards of a relevant country or region in a process of determining such an environmental evaluation grade.

Also, the carbon emission calculating unit 200 compares the calculated carbon emissions with the criterion of the environmental evaluation grade, analyzes which grade a corresponding process belongs to, summarizes carbon emissions for each process, and identifies a major emission source (e.g., energy consumption or process emissions).

Next, the carbon emission calculating unit 200 may evaluate the impact of the calculated carbon emissions on an environment. For example, the impact of greenhouse gas emissions on local and global environments may be reflected. Also, the carbon emission calculating unit 200 may analyze whether additional process improvement is needed to reduce carbon emissions, and may analyze expected costs or environmental benefits when improvement is made.

The carbon emission calculating unit 200 may generate an environmental evaluation grade report to be provided to the management terminal, based on an analysis result.

In an embodiment, in the environmental evaluation grade report, the carbon emission calculating unit 200 may summarize an analysis result of carbon emissions generated in a scrap processing process, may reflect a purpose and a method of environmental evaluation, and may also reflect in detail a process of calculating carbon emissions, performing comparison with an evaluation criterion, determining a grade, and analyzing a major emission source.

Also, in the environmental evaluation grade report, the carbon emission calculating unit 200 may assign an environmental grade (e.g., A, B, C, etc.) according to an environmental evaluation result, may reflect recommendations on a method of reducing carbon emissions through process improvement, and may suggest long-term strategy or additional research needs to reduce environmental impact.

Also, in an embodiment, the carbon emission calculating unit 200 may calculate expected carbon emissions for each type of metal treatment material based on carbon emissions generated in a processing process of the metal scrap, and then may provide a notification to at least one of the management terminal and a control system when it is determined that the expected carbons exceed preset reference carbon emissions.

The carbon emission operation control unit 210 may control operation states of the ventilation device 140, the solar power generation device 180, and the hydraulic energy storage system 190 described above so that, when it is determined that the expected carbon emissions exceed the reference carbon emissions based on a calculation result of the expected carbon emissions, the expected carbon emissions are reduced to below the reference carbon emissions.

For example, when it is determined that the expected carbon emissions exceed the reference carbon emissions, the carbon emission operation control unit 210 may identify a process which is a main cause of the excessed carbon emissions (e.g., a transport process, a classification process, or a crushing process), and then may control an operation of the ventilation device 140 related to the identified process, may control power supply through the solar power generation device 180 related to the identified process, or may control an operation state through the hydraulic energy storage system 190 related to the identified process, to ensure target carbon emissions or less.

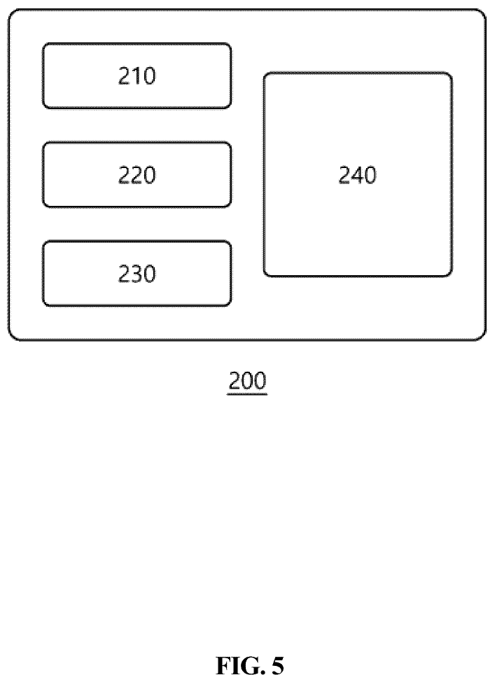

FIG. 5 is a diagram schematically illustrating a hardware configuration of the recycled metal production facility 100 with reduced carbon emissions according to an embodiment of the present disclosure.

Referring to FIG. 5, the recycled metal production facility 100 with reduced carbon emissions according to embodiments may be at least partially operated or controlled by a computing device including hardware 200. In this case, the computing device may include a memory 210, a processor 220, a communication module 230, and an input/output unit 240.

The memory 210 is a non-transitory computer-readable recording medium and may include a permanent mass storage device such as a random-access memory (RAM), a read-only memory (ROM), a disk drive, a solid state drive (SSD), or a flash memory. The permanent mass storage device such as ROM, SSD, flash memory, or disk drive may be stored, as a permanent storage device separate from the memory 210, in the device or a server.

Also, the memory 210 may store an operating system and at least one program code (e.g., code for an application installed to provide a specific service or a security module). Such software components may be loaded from a computer-readable recording medium separate from the memory 210. The separate computer-readable recording medium may include a computer-readable recording medium such as a floppy drive, a disk, a tape, a DVD/CD-ROM drive, or a memory card.

In another embodiment, the software components may be loaded into the memory 210 through the communication module 230, rather than the computer-readable recording medium. For example, at least one program may be loaded into the memory 210 based on a computer program installed by files provided through a network by a file distribution system (e.g., an application store service server) that distributes installation files of applications or developers.

The processor 220 may be configured to process a command of a computer program by performing basic arithmetic, logic, and input/output operations. The command may be provided to the processor 220 by the communication module 230 or the memory 210. For example, the processor 220 may be configured to execute a command received according to program code stored in a recording device such as the memory 210.

The communication module 230 may provide a function using which the computing device communicates with a user terminal (not shown) through a network. Also, the communication module 230 may provide a function using which the computing device communicates with one or more other devices through a wired/wireless network. That is, the communication module 230 is a portion whose function is controlled by the processor 220 referencing the memory 210 to implement each functional module described with reference to FIG. 5.

The input/output unit 240 may be a means for interfacing with an external input/output device (not shown). For example, the external input device may include a device such as a keyboard, a mouse, a microphone, or a camera, and the external output device may include a device such as a display, a speaker, or a haptic feedback device. In another example, the input/output unit 240 may be a means for interfacing with a device in which input and output functions are integrated, such as a touchscreen.

Also, in other embodiments, the computing device for operating or controlling the recycled metal production facility 100 with reduced carbon emissions may include more hardware components than those illustrated in FIG. 4 according to the nature of an applied device. For example, the computing device may include at least some of the above input/output devices or may further include other components such as a transceiver, a global positioning system (GPS) module, a camera, various sensors, and a DB. In a more specific example, when a terminal device is a smartphone, the computing device may further include various components such as an acceleration sensor or a gyro sensor, a camera module, various physical buttons, buttons using a touch panel, an input/output port, and a vibrator for vibration which are generally provided in a smartphone.

However, components and a shape of the computing device described in the specification are only examples, and a configuration of the computing device implemented for the recycled metal production facility 100 with reduced carbon emissions may be different from that described in the specification according to the adoption of other known technologies or further development of information and communication technologies.

Next, a method of processing recycled metal by using the recycled metal production facility 100 with reduced carbon emissions described above will be sequentially described.

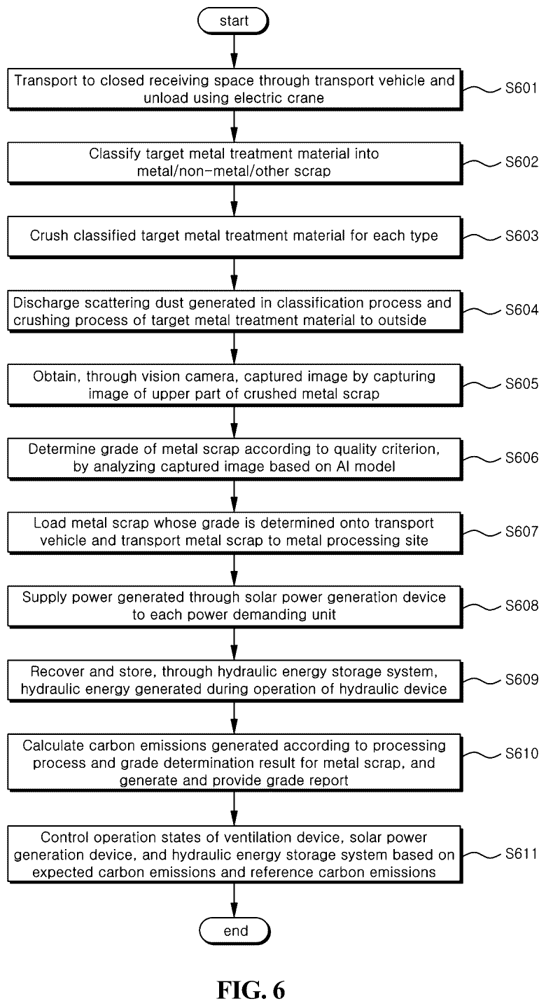

FIG. 6 is a flowchart sequentially illustrating a series of operations of a method of operating a recycled metal production facility with reduced carbon emissions according to an embodiment of the present disclosure.

Referring to FIG. 6, the recycled metal production facility 100 with reduced carbon emissions according to an embodiment of the present disclosure accommodates a transported target metal treatment material in a closed receiving space by using a plurality of electric cranes installed in the closed receiving space (S601), and classifies, through a scrap classifying line installed in the closed receiving space, the target metal treatment material into metal scrap, non-metal scrap, and other scrap (S602).

Next, the recycled metal production facility 100 with reduced carbon emissions crushes, through a crushing line installed in the closed receiving space, the classified target metal treatment material for each type (S603).

In this case, through a ventilation device installed on a side of the closed receiving space, scattering dust generated in a classification process and a crushing process of the target metal treatment material is discharged to the outside (S604), and operation S604 may always be performed throughout an entire process of processing metal scrap.

Next, the recycled metal production facility 100 with reduced carbon emissions obtains, through a vision cameral installed above the metal scrap, a captured image by capturing an image of an upper part of the metal scrap (S605), and determines, through a grade determining unit, a grade of the metal scrap according to a preset quality criterion by analyzing the captured image based on an AI model (S606).

In operation S606, the grade determining unit may identify a type of the metal scrap by analyzing a material, a color, and a surface condition of the metal scrap based on the captured image obtained through the vision camera 150 and may classify by size or determine a processing process by measuring a length, a width, and a thickness of the metal scrap, and may also inspect a grade by detecting defects or impurities on the surface of the metal scrap.

Next, the recycled metal production facility 100 with reduced carbon emissions loads, through a transport unit installed in the closed receiving space, the metal scrap whose grade is determined onto an electric transport vehicle and transport the metal scrap to a metal processing site (S607), and supplies, through solar power generation of a solar power generation device installed outside the closed receiving space, power to a power demanding unit from among the scrap classifying line, the crushing line, the ventilation device, the vision camera, the grade determining unit, and the transport unit (S608).

Also, the recycled metal production facility 100 with reduced carbon emissions recovers and stores, through a hydraulic energy storage system installed in at least one hydraulic device located in the closed receiving space during a classification and crushing process of the target metal treatment material and a loading process of the metal scrap, hydraulic energy generated during an operation of the at least one hydraulic device (S609).

Next, a carbon emission calculating unit calculates carbon emissions generated in a processing process of the metal scrap and a grade determination result for the metal scrap, generates a grade report on recycled metal based on the carbon emissions, and provides the grade report to a management terminal (S610).

In operation S610, the carbon emission calculating unit may calculate carbon emissions based on a material consumed in a metal scrap processing plant and corresponding energy consumption.

Also, in operation S610, the carbon emission calculating unit may determine carbon emissions generated in a process of processing a specific amount of specific classified metal scrap by using an AI model.

Also, in operation S610, the carbon emission calculating unit may compare the calculated carbon emissions with a criterion of an environmental evaluation grade, may analyze which grade a corresponding process belongs to, may summarize carbon emissions for each process, may identify a major emission source (e.g., energy consumption or process emissions), and may generate an environmental evaluation grade report to be provided to the management terminal based on an analysis result.

Next, the recycled metal production facility 100 with reduced carbon emissions may control, through a carbon emission operation control unit, operation states of the ventilation device, the solar power generation device, and the hydraulic energy storage system so that, based on a calculation result of expected carbon emissions, the expected carbon emissions are reduced below reference carbon emissions (S611).

The method may be provided as a computer program stored in a computer-readable recording medium for execution on a computer. The medium may continuously store a computer-executable program, or may temporally store a computer-executable program for execution or download. Also, the medium may be any of various recording media or storage media having a single piece of hardware or a combination of several pieces of hardware, and the medium is not limited to a medium directly connected to a computer system, but may be distributed on a network. Examples of the medium may include magnetic media such as a hard disk, a floppy disk, and a magnetic tape, optical recording media such as a CD-ROM and a DVD, magneto-optical media such as a floptical disk, and devices configured to store program instructions such as a ROM, a random-access memory (RAM), and a flash memory. Also, other examples of the medium may include recording media and storage media managed by application stores distributing applications or by websites, servers, and the like supplying or distributing other various types of software.

The methods, operations, or techniques of the present disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the present disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design constraints imposed on a particular application and an overall system. Those skilled in the art may implement the described functions in varying ways for each particular application, but such decisions for implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described herein, a computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random-access memory (RAM), read-only memory (ROM), non-volatile random-access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described herein.

When implemented in software, the functions may be stored on a computer-readable medium as one or more instructions or codes, or may be transmitted through a computer-readable medium. Computer-readable media include both computer storage media and communication media including any medium that facilitate transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that may be used to transfer or store desired program code in the form of instructions or data structures and may be accessed by a computer. Also, any connection is properly referred to as a computer-readable medium.

Although example implementations have been described as utilizing aspects of the presently disclosed subject matter in one or more standalone computer systems, the present disclosure is not limited thereto, and may be implemented in conjunction with any computing environment, such as a network or distributed computing environment. Furthermore, aspects of the presently disclosed subject matter may be implemented in a plurality of processing chips or devices, and storage may be similarly influenced across a plurality of devices. Such devices may include PCs, network servers, and portable devices.

Although the present disclosure has been described in connection with some embodiments herein, it should be understood that various modifications and changes may be made without departing from the scope of the present disclosure, which may be understood by those skilled in the art to which the present disclosure pertains. In addition, such modifications and changes should be considered within the scope of the claims appended herein.

What is claimed is:

1. A recycled metal production facility with reduced carbon emissions, comprising:
a closed receiving space in which a transported target metal treatment material is accommodated;
a scrap classifying line installed in the closed receiving space and configured to classify the target metal treatment material into metal scrap, non-metal scrap, and other scrap;
a crushing line installed in the closed receiving space and configured to crush the classified target metal treatment material for each type;
a ventilation device installed on a side of the closed receiving space and configured to discharge scattering dust generated in a classification process and a crushing process of the target metal treatment material to outside;
a vision camera configured to obtain a captured image by capturing an image of an upper part of metal scrap that is crushed;
a grade determining unit configured to determine a grade of the metal scrap according to a preset quality criterion, by analyzing the captured image based on an artificial intelligence (AI) model;
a transport unit installed in the closed receiving space and configured to load the metal scrap whose grade is determined onto an electric transport vehicle and transport the metal scrap to a metal processing site;
a solar power generation device installed outside the closed receiving space and configured to supply power to a power demanding unit from among the scrap classifying line, the crushing line, the ventilation device, the vision camera, the grade determining unit, and the transport unit through solar power generation; and
a hydraulic energy storage system installed in at least one hydraulic device located in the closed receiving space and configured to recover and store hydraulic energy generated during an operation of the at least one hydraulic device.

2. The recycled metal production facility with reduced carbon emissions according to claim 1, wherein the grade determining unit is configured to
classify a grade of the metal scrap according to whether the metal scrap corresponds to a vehicle outer skin, the metal scrap has a thickness of 3 mm or less, and the metal scrap has a thickness of 3 mm or less and is surface-plated, based on the captured image obtained through the vision camera, and
filter out shadow noise formed by lighting, a thermal noise component, and a dust noise component formed by scattering dust in the obtained captured image, and then perform Fourier transform on the filtered captured image.

3. The recycled metal production facility with reduced carbon emissions according to claim 1, further comprising a carbon emission calculating unit configured to calculate carbon emissions generated in a processing process of the metal scrap and a grade determination result for the metal scrap, generate a grade report on recycled metal based on the carbon emissions, and provide the grade report to a management terminal.

4. The recycled metal production facility with reduced carbon emissions according to claim 3, wherein the carbon emission calculating unit is configured to calculate expected carbon emissions for each type of metal treatment material based on the carbon emissions generated in the processing process of the metal scrap, and then provide a notification to at least one of the management terminal and a control system when it is determined that the expected carbons exceed preset reference carbon emissions.

5. The recycled metal production facility with reduced carbon emissions according to claim 4, further comprising a carbon emission operation control unit configured to control operation states of the ventilation device, the solar power generation device, and the hydraulic energy storage system so that, based on a calculation result of the expected carbon emissions, the expected carbon emissions are reduced to below the reference carbon emissions.

6. A method of operating a recycled metal production facility with reduced carbon emissions, the method comprising:
accommodating a transported target metal treatment material in a closed receiving space;
classifying, through a scrap classifying line installed in the closed receiving space, the target metal treatment material into metal scrap, non-metal scrap, and other scrap;
crushing, through a crushing line installed in the closed receiving space, the classified target metal treatment material for each type;
discharging, through a ventilation device installed on a side of the closed receiving space, scattering dust generated in a classification process and a crushing process of the target metal treatment material to outside;
obtaining, through a vision camera, a captured image by capturing an image of an upper part of the metal scrap that is crushed;
determining, through a grade determining unit, a grade of the metal scrap according to a preset quality criterion, by analyzing the captured image based on an artificial intelligence (AI) model;
through a transport unit installed in the closed receiving space, loading the metal scrap whose grade is determined onto an electric transport vehicle and transporting the metal scrap to a metal processing site;
supplying, through solar power generation of a solar power generation device installed outside the closed receiving space, power to a power demanding unit from among the scrap classifying line, the crushing line, the ventilation device, the vision camera, the grade determining unit, and the transport unit;
recovering and storing, through a hydraulic energy storage system installed in at least one hydraulic device located in the closed receiving space, hydraulic energy generated during an operation of the at least one hydraulic device;
through a carbon emission calculating unit, calculating carbon emissions generated in a processing process of the metal scrap and a grade determination result for the metal scrap, generating a grade report on recycled metal based on the carbon emissions, and providing the grade report to a management terminal; and
controlling, through a carbon emission operation control unit, operation states of the ventilation device, the solar power generation device, and the hydraulic energy storage system so that, based on a calculation result of expected carbon emissions, the expected carbon emissions are reduced to below reference carbon emissions.
